(19) United States
(12) Patent Application Publication
(10) Pub. No.: US 2014/0372993 A1
(43) Pub. Date: Dec. 18, 2014

(54) OVERLOADING ON CONSTANTS

(71) Applicant: Microsoft Corporation, Redmond, WA (US)

(72) Inventors: Lucas J. Hoban, Seattle, WA (US); Jonathan D. Turner, Seattle, WA (US); Mads Torgersen, Issaquah, WA (US); Charles P. Jazdzewski, Redmond, WA (US); Joseph J. Pamer, Seattle, WA (US); Steven E. Lucco, Bellevue, WA (US); Anders Hejlsberg, Seattle, WA (US); Robert A. Paveza, Redmond, WA (US)

(21) Appl. No.: 13/917,687

(22) Filed: Jun. 14, 2013

(51) Int. Cl. G06F 9/45

(52) U.S. Cl. CPC G06F 8/437
USPC 717/143

(57) ABSTRACT

A function in a type system can be overloaded using specified constants. The constant can be can be the result of evaluating an expression to: a string, a number, a Boolean, a pattern or any type of constant. The return type of the function can depend on the specified constant that is passed into the function. The return type of the function can depend on the type of the specified constant that is passed into the function. The type of the parameter that is passed into the function can depend on the value of the constant. The function overloads can be validated to ensure that the constant-based overload is a subtype of a more general overload. A constant can be an expression used at compile time during type checking.

### BACKGROUND

A programming language in which the data type of an entity is validated at run-time is a dynamically typed language. A programming language in which the data type of an entity is validated at compile time is a statically typed language. A type signature defines inputs to and/or outputs from a program element. Overloading refers to the ability to associate one identifier for a program element with multiple valid type signatures. Overloading can be used in programming languages that enforce type checking of function calls during compilation to express the legal ways in which the function can be called.

### SUMMARY

A function in a type system can be overloaded using specified constants. The constant can be the result of evaluating an expression at compile time to determine that the expression evaluates to a string, a number, a Boolean, a date, a constant made up of one or more parts, a pattern or any type of constant. The return type of the function can depend on the specified constant that is passed into the function. The type of a second parameter that is passed into the function can depend on the value of the constant passed into the function. A function in a type system can be overloaded using constants by overloading an existing function having a corresponding parameter of the type of the constant. The function overloads can be validated to ensure that the constant-based overload is a subtype of a more general overload. A constant can be an expression used at compile time during type checking. Type inference can use signatures which are overloaded on constants to help infer a more accurate type for a call expression.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 that captures type information associated with overloaded constants in accordance with aspects of the subject matter described herein;

FIG. 1b illustrates an example of parse trees representing fragments of program source code in which typing information has been captured in accordance with aspects of the subject matter disclosed herein;

FIG. 2 illustrates an example of a method 200 that captures type information using overloaded typing in accordance with aspects of the subject matter disclosed herein;

FIG. 3 is a block diagram of an example of a computing environment in accordance with aspects of the subject matter disclosed herein.

FIG. 4 is a block diagram of an example of an integrated development environment (IDE) in accordance with aspects of the subject matter disclosed herein.

### DETAILED DESCRIPTION

### Overview

A program can attribute a semantic meaning to a particular value of an input in a way that impacts the signature. For example, a program may take a string where the value of the string determines the type of what is returned. As a particular example, passing “div” as the argument to the W3C Document Object Model (DOM) “document.create(elementName)” can result in the return of an HTMLDivElement. This type information is typically not collected by the compiler of a statically typed programming language. For example, the program segment in the previous paragraph is traditionally written as:
create(elementName: string): Element
   meaning create an element with the name “elementName” which is a string data type and return the created element, Element. There is no indication that passing the constant value “div” as the argument leads to creation of an HTMLDivElement. There is no indication that passing the constant value “div” as the argument leads to returning the created HTMLDivElement as the result. Sometimes, the loss of information is compensated for by cumbersome coding patterns, including but not limited to adding potentially unsafe cast expressions that attempt to recapture the lost type information.

In statically typed programming languages which use bottom-up type inference, the data type returned from a function call is derived from the types of the argument expression to that call, combined with the overloaded signatures of the function. In accordance with aspects of the subject matter disclosed herein, a typing module of a compiler captures type information from source code that defines overloaded functions using constants. The typed parse tree created can be used by static analysis tools, auto-completion tools, etc. to provide additional information to a developer during design time.

### Overloading on Constants

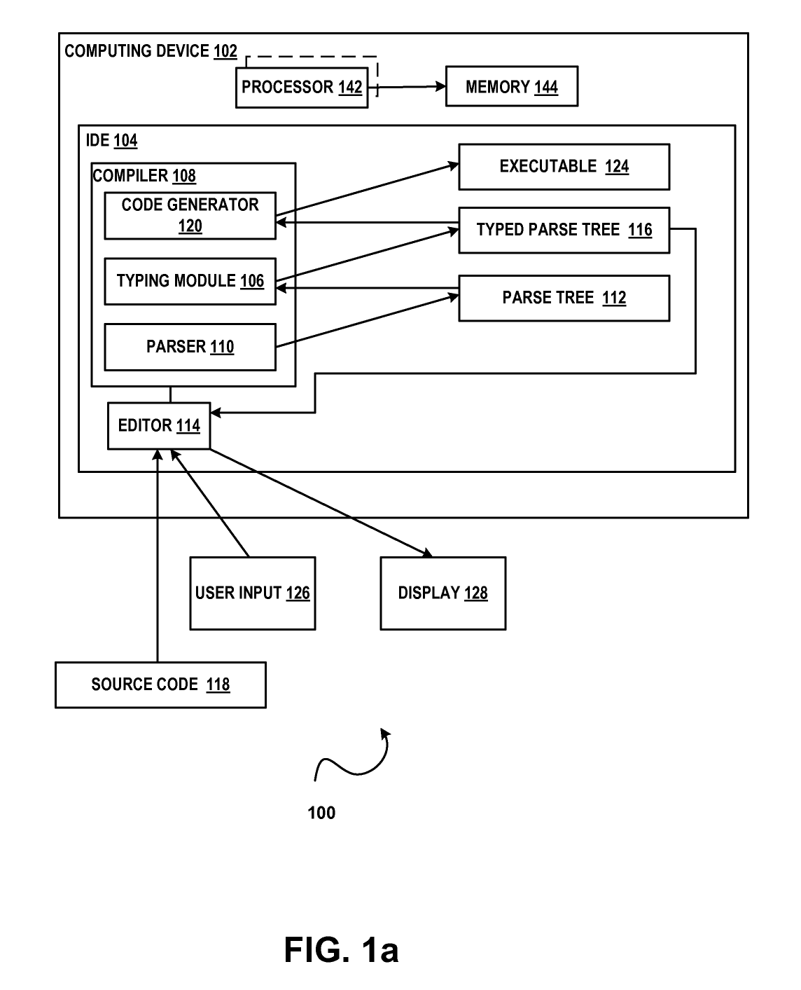

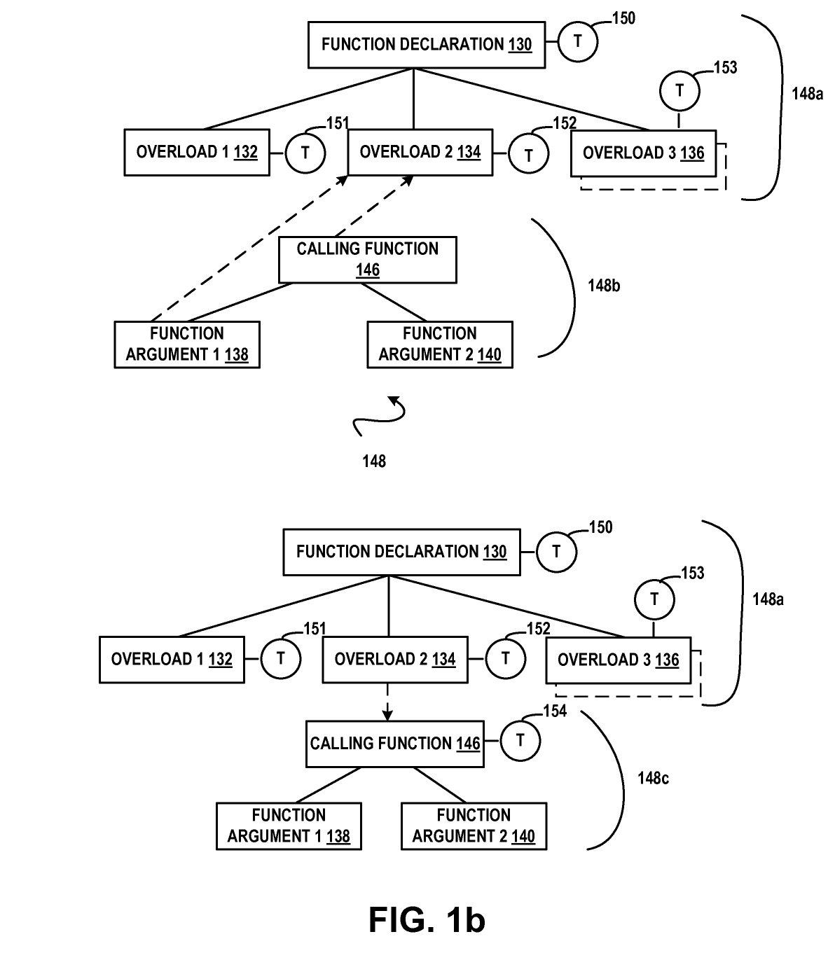

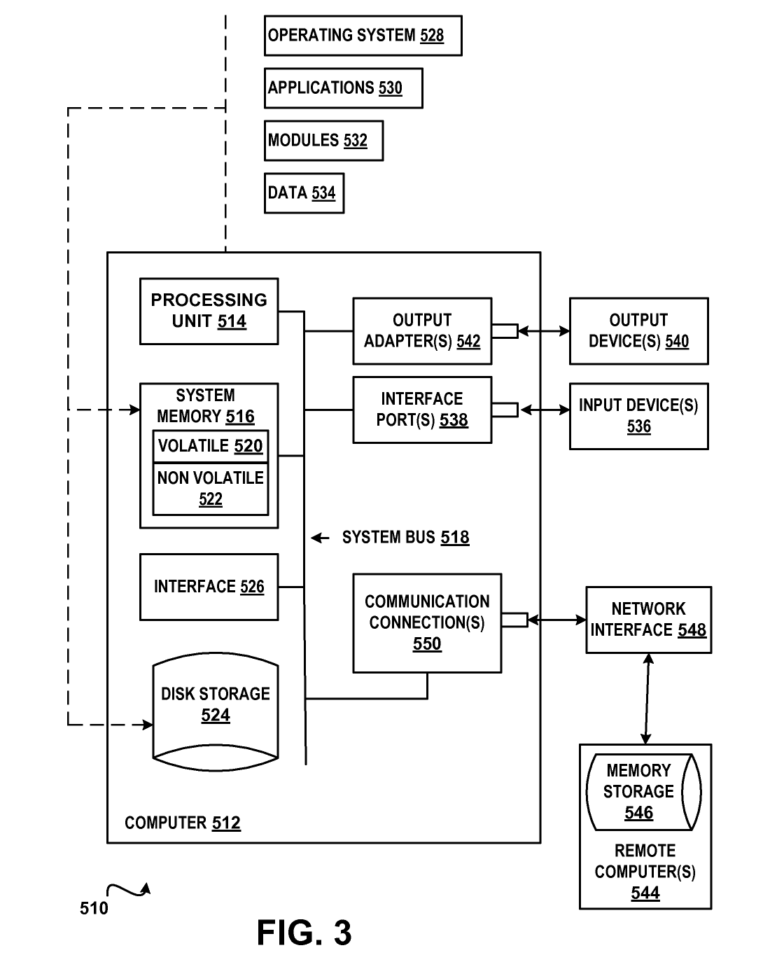

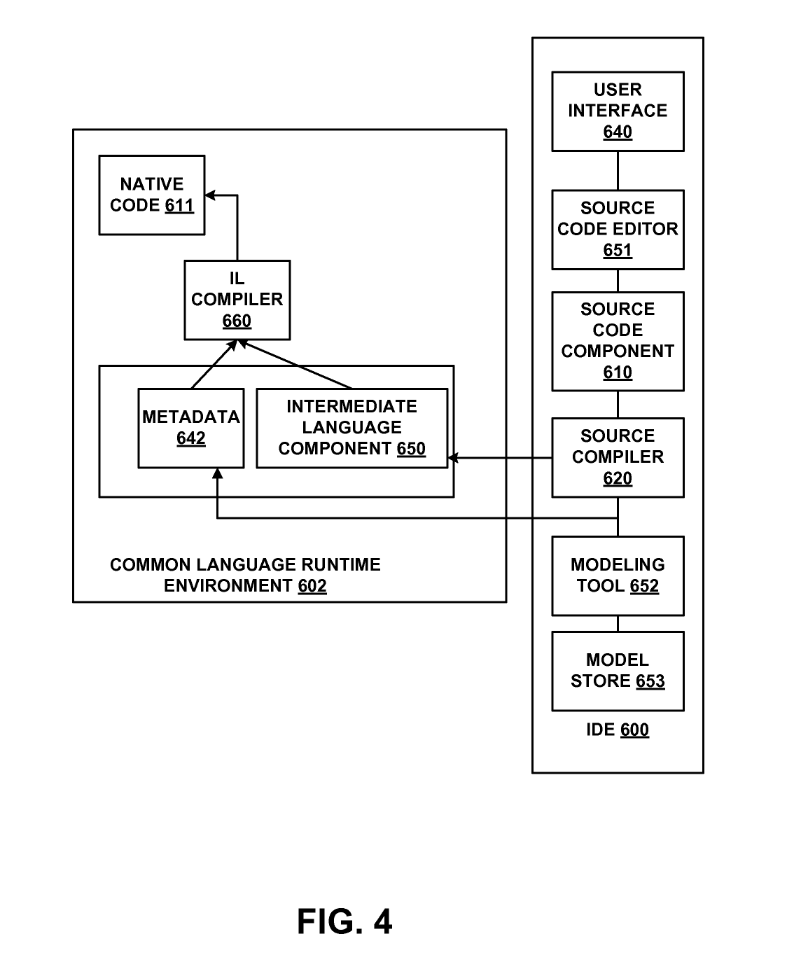

FIG. 1a illustrates a block diagram of an example of a system 100 in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in. System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud. System 100 may execute in whole or in part on a software development computer such as the software development computer described with respect to FIG. 4. All or portions of system 100 may be operated upon by program development tools. For example, all or portions of system 100 may execute within an integrated development environment (IDE) such as for example IDE 104. IDE 104 may be an IDE as described more fully with respect to FIG. 4 or can be another IDE. System 100 can execute wholly or partially outside an IDE.

System 100 can include one or more computing devices such as, for example, computing device 102. A computing device such as computing device 102 can include one or more processors such as processor 142, etc., and a memory such as memory 144 connected to the one or more processors. Computing device 102 can include one or more modules comprising a compiler such as compiler 108. A compiler such as compiler 108 may be a computer program or set of programs that translates text written in a (typically high-level) programming language into another (typically lower-level) computer language (the target language). The output of the compiler may be object code. Typically the output is in a form suitable for processing by other programs (e.g., a linker), but the output may be a human-readable text file. Source code is typically compiled to create an executable program but may be processed by program development tools which may include tools such as editors, beautifiers, static analysis tools, refactoring tools and others that operate in background or foreground.

A compiler 108 may comprise a .NET compiler that compiles source code written in a .NET language to intermediate byte code. .NET languages include but are not limited to C#, C++, F#, J#, JScript.NET, Managed Jscript, IronPython, IronRuby, VBx, VB.NET, Windows PowerShell, A#, Boo, Cobra, Chrome (Object Pascal for .NET, not the Google browser), Component Pascal, IKVM.NET, IronLisp, L#, Lexico, Mondrian, Nemerle, P#, Phalanger, Phrogram, PowerBuilder, #Smalltalk, AVR.NET, Active Oberon, APLNext, Common Larceny, Delphi.NET, Delta Forth .NET, DotLisp, EiffelEnvision, Fortran .NET, Gardens Point Modula-2/CLR, Haskell for .NET, Haskell.net, Hugs for .NET, IronScheme, LOLCode.NET, Mercury on .NET, Net Express, NetCOBOL, OxygenScheme, S#, sml.net, Wildcat Cobol, X#, TypeScript or any other .NET language. Compiler 108 may comprise a JAVA compiler that compiles source code written in JAVA to byte code. Compiler 108 can be any compiler for any programming language including but not limited to Ada, ALGOL, SMALL Machine Algol Like Language, Ateji PX, BASIC, BCPL, C, C++, CLIPPER 5.3, C#, CLEO, CLush, COBOL, Cobra, Common Lisp, Corn, Curl, D, DASL, Delphi, DIBOL, Dylan, dylan.NET, eC (Ecere C), Eiffel, Sather, Ubercode, eLispEmacs Lisp, Erlang, Factor, Fancy, Formula One, Forth, Fortran, Go, Groovy, Haskell, Harbour, Java, JOVIAL, LabVIEW, Nemerle, Obix, Objective-C, Pascal, Plus, ppC++, RPG, Scheme, Smalltalk, ML, Standard ML, Alice, OCaml, Turing, Urq, Vala, Visual Basic, Visual FoxPro, Visual Prolog, WinDev, X++, XL, and/or Z++. Compiler 108 can be a compiler for any typed programming language.

A compiler such as compiler 108 and/or program development tools are likely to perform at least some of the following operations: preprocessing, lexical analysis, parsing (syntax analysis), semantic analysis, code generation, and code optimization. Compiler 108 may include one or more modules comprising a parser such as parser 110 that receives program source code and generates a parse tree such as parse tree 112. Parser 110 can be a background parser, parallel parser or incremental parser. Parser 110 can be a pre-processor, or a plug-in or add-in or an extension to an IDE, parser, compiler or pre-processor. Parser 110 can include a syntax analyzer that may perform syntax analysis. Syntax analysis involves parsing a token sequence to identify the syntactic structure of the program. The syntax analysis phase typically builds a parse tree such as parse tree 112. A parse tree replaces the linear sequence of tokens in the program source code with a tree structure built according to the rules of a formal grammar which define the syntax of the programming language. The parse tree is often analyzed, augmented, and transformed by later phases in the compiler. Compiler 108 may also include a code generator such as code generator 120 that receives a parse tree such as typed parse tree 116 or parse tree 112 and generates an executable such as executable 124. Compiler 108 may also include other components known in the art.

System 100 can include one or more modules such as typing module 106 that performs typing derived from overloading constants as described herein. Typing module 106 can be a part of compiler 108, as illustrated in FIG. 1a or can be a separate entity, plug-in, or add-on (not shown). Typing module 106 can receive a parse tree such as parse tree 112 and produce a typed parse tree such as typed parse tree 116. It will be appreciated that one or more modules such as for example, typing module 106 can be loaded into memory 144 to cause one or more processors such as processor 142, etc. to perform the actions attributed to typing module 106. System 100 can include any combination of one or more of the following: an editor such as but not limited to editor 114, a display device such as display 128, and so on. Editor 114 can receive source code such as source code 118 and user input such as user input 126. Because type information associated with the overloaded functions is persisted in the typed parse tree, program development tools including but not limited to auto-completion tools (such as but not limited to Microsoft's IntelliSense®) and static analysis tools can include type information associated with overload on constants. That is, type information such as but not limited to displaying the type of an expression for which the type was determined by typing derived from overloading constants, a list of overloads for a function signature, etc. can be displayed on a display device such as display 128. Overloading on constants can allow languages which use type inference to infer more accurate types, displaying more accurate information in an IDE and catching more potential bugs in the user program. An IDE can use the information about overloads on constants to suggest values to pass to a call. For example, in the “addEventListener” example below, a user typing “addEventListener” can be prompted with a list including “mousemove”, “mouseup” and “blur”. Other components well known in the arts may also be included but are not here shown.

In accordance with some aspects of the subject matter described herein, compiler 108 can receive source code such as but not limited to TypeScript source code and can generate an executable such as but not limited to JavaScript executable output. The source code 118 may include a function that takes a parameter whose value implies something about the type that will be returned. Suppose for example, a fragment of source code 118 is:

var canv = document.createElement(‘canvas’);
canv.getContext(‘2d’);

In the source code above, the string constant argument “canvas” is passed to the “createElement” function in the Document Object Model (DOM). “createElement(tagName: string): HTMLElement;” is the simplest signature of the function createElement. Because a specified constant comprising the string “canvas” is passed to the “createElement” function, the function returns an “HTMLCanvasElement”. “HTMLCanvasElement” can be used to call the function “getContext”. In traditional statically typed languages, the code above requires a cast because the connection between “canvas” and “HTMLCanvasElement” is otherwise not available to the compiler. A compiler error would be generated in the absence of a cast.

In accordance with aspects of the subject matter described herein, a typing module 106 of the compiler 108 maps a constant specified in the signature of the function (in the example code above, the constant “canvas”) to a return type (in the example code above, the return type “HTMLCanvasElement”), persisting the mapping information in the typed parse tree 116. A function that takes a parameter can have multiple overloaded signatures that take specified constants as parameters. Additional specified types can appear elsewhere in the signature. For example, for the “createElement” function of the previous example, an overloaded parameter may appear as follows:

interface Document {

createElement(tagName: string): HTMLElement;
createElement(tagName: ‘canvas’): HTMLCanvasElement;
createElement(tagName: ‘div’): HTMLDivElement;
createElement(tagName: ‘span’): HTMLSpanElement;
// additional specified constants can be added

}

If the “createElement” function is called with an argument that is a specified constant, (e.g., in the example above, one of the specified constants “canvas”, “div” or “span”), the type associated with the constant is returned (e.g., the HTMLCanvasElement, HTMLDivElement, HTMLSpanElement respectively). If “createElement” is called with an argument that is not a specified constant, the default “HTMLElement” is returned.

Suppose, for example a fragment of source code 118 is:

document.addEventListener(‘mousemove’, ev => {

ev.clientX;

});

The above fragment of source code represents the “addEventListener” pattern in DOM. Similar patterns appear in event and callback-based APIs in many languages. Traditionally, the type of “ev” is inferred to be “Event”, the base class of all possible event callback object types that “addEventListener” might pass.

A traditional static language compiler generates an error from this code because the “clientX” property does not exist on all “Event”s. Because the “mousemove” event always provides a “MouseEvent” argument, an association between “mousemove” as the first argument to addEventListener, and the parameter type of the callback (the second parameter) to addEventListener can be established, as follows:

interface EventTarget {

addEventListener(type: string, listener: (evt: Event) => void): void;
addEventListener(type: ‘mousemove’, listener: (evt: MouseEvent) =>
void): void;
addEventListener(type: ‘mouseup’, listener: (evt: MouseEvent) =>
void): void;
addEventListener(type: ‘blur’, listener: (evt: FocusEvent) => void):
void;
// additional overload definitions

}

This example of code illustrates that a function addEventListener can be passed any string as its first argument, and can pass an Event to the function that is its second argument. In addition, if the function is passed specific string constant values for its first argument, (e.g., one of “mousemove”, “mouseup”, “blur” or any values specified in the “additional overload definitions, if any) more information is available on what type will be passed into the function that is its second argument. For example, if the first argument is “mousemove”, the function that “MouseEvent” event will be passed to is the “MouseEvent” function.

A function in a type system can be overloaded using specified constants that are literals, as described above. The constant can also be a number, a nonlimiting example of which is:
getDataForDay(dayOfTheWeek: 1, callback: (evt: MondayData)=>void): void;
   a Boolean (the constant resolves to True or False). The constant can also be the result of evaluating an expression (when the expression resolves to 1, return x, etc.), or a pattern (e.g., an example of a pattern may be: when the literal starts with a “c” and ends with an “s” return HTMLCanvasElement) or any type of constant. The return type of the function can depend on the specified constant that is passed into the function. The return type of the function can depend on the type of the specified constant that is passed into the function. The type of the parameter that is passed into the function can be based on the value of the constant. The parameter passed into the function can be of type “function”, modeling a callback. In a type system, a function taking a particular parameter type can be overloaded, where the parameter the function takes depends on a constant associated with the function. A function in a type system can be overloaded using constants by overloading an existing function having a corresponding parameter of the type of the constant. The function overloads can be validated to ensure that the constant-based overload is a subtype of a more general overload. A constant can be an expression used at compile time during type checking.

FIG. 1b illustrates an example 148 of parse trees representing fragments of program source code in accordance with aspects of the subject matter disclosed herein. The parse tree 148a of FIG. 1b represents a typed parse tree for a function declaration 130 that has multiple overloads including overload 1 132, overload 2 134, overload 3 136 and so on. Parse tree 148a is a typed parse tree because the nodes of the parse tree are annotated with type information, represented in FIG. 1b by T 150 for the node representing the function declaration 130, T 151 for the node representing overload 1 132, T 152 for the node representing overload 2 134, T 153 for the node representing overload 3 136.

Parse tree 148b illustrates the parse tree of a program element, calling function 146. Calling function 146 calls the function declared by function declaration 130. Calling function 146 has two function arguments: function argument 1 138 and function argument 2 140. Parse tree 148b is an untyped parse tree because the nodes of parse tree 148b are not annotated with type information. Suppose that function argument 1 138 is a string constant whose value is “S”. In accordance with aspects of the subject matter disclosed herein, during function resolution a typing module of the compiler can map a constant specified in a signature of the function (in the example code above, the constant “S”) to a particular overload (in the example, to overload 2 134). An overload can be associated with type information including a specified return type (e.g., overload 2 134 is associated with type information T 152 which can include a type associated with a return). The return type of overload 2 134 can then be assigned to the calling function 146 to create typed parse tree 148c, in which type information T 154 has been added to the node representing the calling function 146.

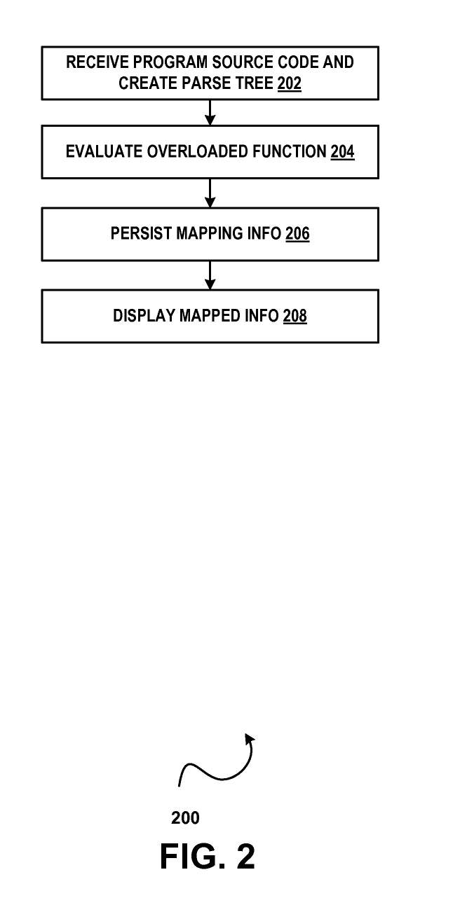

FIG. 2 illustrates an example of a method 200 that captures type information using overloaded constants in accordance with aspects of the subject matter disclosed herein. The method described in FIG. 2 can be practiced by a system such as but not limited to the one described with respect to FIG. 1a and for which an example was provided in FIG. 1b. While method 200 describes a series of operations that are performed in a sequence, it is to be understood that method 200 is not limited by the order of the sequence. For instance, some operations may occur in a different order than that described. In addition, one operation may occur concurrently with another operation. In some instances, not all operations described are performed.

At operation 202 program source code can be received and a parse tree can be created therefrom. Each expression in the parse tree can be represented by a subtree of the parse tree. At operation 204 an expression comprising a function definition can be evaluated. The parameter or constant value comprising input to a function can be evaluated. The purpose of evaluating the parameter or constant value is to determine the return type that can be associated with the function having that parameter or constant value. A function in a type system can be overloaded using specified constants.

The constant can be can be a string, a number, a Boolean, the result of evaluating an expression or any type of constant. The return type of the function can depend on the specified constant that is passed into the function. The return type of the function can depend on the type of the specified constant that is passed into the function. The type of the parameter that is passed into the function can be based on the value of the constant. The parameter passed into the function can be of type “function”, modeling a callback. In a type system, a function taking a particular parameter type can be overloaded, where the parameter the function takes depends on a constant associated with the function. A function in a type system can be overloaded using constants by overloading an existing function having a corresponding parameter of the type of the constant. The function overloads can be validated to ensure that the constant-based overload is a subtype of a more general overload. A constant can be an expression used at compile time during type checking.

At operation 206 the results to be associated with the parameter or constant value can be persisted to the typed parse tree so that information from the source code that is used to overload a function parameter is mapped to information associated with the overloaded function parameter. This information can include the return type of the function, type information for a second parameter, a parameter of a set of parameters associated with the overloading constant, and so on. At operation 208 the typed parse tree can be used by static analysis tools, auto-completion tools etc. to provide additional information on the display device at design time. Because type information associated with the overloaded functions is persisted in the typed parse tree, program development tools including but not limited to auto-completion tools (such as but not limited to Microsoft's IntelliSense®) and static analysis tools can include type information associated with overload on constants. That is, type information such as but not limited to displaying the type of an expression for which the type was determined by typing derived from overloading constants, a list of overloads for a function signature, etc. can be displayed on a display device such as display 128. Overloading on constants can allow languages which use type inference to infer more accurate types, displaying more accurate information in an IDE and catching more potential bugs in the user program. An IDE can use the information about overloads on constants to suggest values to pass to a call. For example, in the “addEventListener” example below, a user typing “addEventListener” can be prompted with a list including “mousemove”, “mouseup” and “blur”. Suppose for example, a fragment of source code is:

var canv = document.createElement(‘canvas’);
canv.getContext(‘2d’);

instead of displaying “string” in program development tools in a list of possible overloads, or an error message, etc., “canvas” can be displayed.

It will be appreciated that although described within the context of a particular programming language (i.e. TypeScript), the subject matter described herein is applicable to any typed language.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangiblemedia which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++. C#, J#, Java Script, APL, COBOL, Pascal, Eiffel, Haskell, ML, Oberon, Pert, Python, Scheme, Smalltalk and the like). The IDE 600 may provide a native code development environment or may provide a managed code development that runs on a virtual machine or may provide a combination thereof. The IDE 600 may provide a managed code development environment using the Microsoft .NET™ framework. An intermediate language component 650 may be created from the source code component 610 and the native code component 611 using a language specific source compiler 620 using a modeling tool 652 and model store 653 and the native code component 611 (e.g., machine executable instructions) is created from the intermediate language component 650 using the intermediate language compiler 660 (e.g. just-in-time (JIT) compiler), when the application is executed. That is, when an intermediate language (IL) application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor: and
a module that when loaded into the memory causes the at least one processor to:
receive program source code written in a statically typed programming language, the program source code comprising an overloaded function, the overloaded function receiving at least one parameter comprising a constant of a plurality of valid constants for the at least one input parameter, the overloaded function returning at least one result, a type of the at least one result dependent on the received constant, a value of the constant specified in the program source code; and
display type information associated with the at least one result.

2. The system of claim 1, further comprising:
a module that when loaded into the memory causes the at least one processor to:
receive a typed parse tree representing the program source code; and
display a list of overloads for a function signature, the list of overloads comprising a plurality of constants such that a constant of the plurality of constants is associated with a return result associated with the constant.

3. The system of claim 1, further comprising:
a module that when loaded into the memory causes the at least one processor to:
receive the at least one parameter to the overloaded function, the at least one parameter comprising a result of evaluating an expression, the result comprising one of: a string, a number, a Boolean, a date, a constant made up of a plurality of parts, or a pattern.

4. The system of claim 1, wherein a type of a second parameter passed into the overloaded function is determined by a value of the at least one parameter received by the overloaded function.

5. The system of claim 1, further comprising:
a module that when loaded into the memory causes the at least one processor to:
pass the at least one parameter comprising a parameter of type “function” into the overloaded function.

6. The system of claim 1, further comprising:
a module that when loaded into the memory causes the at least one processor to:
receive the at least one parameter, wherein the at least one parameter for the overloaded function depends on a constant associated with the overloaded function.

7. The system of claim 1, further comprising:
a module that when loaded into the memory causes the at least one processor to:
receive the at least one parameter to the overloaded function, the at least one parameter comprising an expression used for type checking.

8. A method comprising:
receiving a typed parse tree representing program source code by a processor of a software development computer, the program source code comprising a function that receives at least one input parameter, the at least one input parameter comprising a constant of a plurality of valid constants, the function returning at least one result, a type of the at least one result dependent on the at least one input parameter;
mapping a constant specified in a signature of the function to a particular overload of the function;
displaying type information associated with the particular overload for the at least one result.

9. The method of claim 8, further comprising:
validating a constant-based function overload by determining that the constant-based function overload is a subtype of a general overload.

10. The method of claim 9, further comprising:
displaying a list of function overload signatures for the function.

11. The method of claim 8, further comprising:
receiving the constant comprising a string, a number, a Boolean, a date, a constant made up of one or more parts or a pattern.

12. The method of claim 8, further comprising:
receiving a second parameter for the function, the at least one input parameter comprising a first parameter, wherein a type of the second parameter depends on a value of the constant passed into the function.

13. The method of claim 8, further comprising;
overloading a function in a type system using a constant by overloading an existing function having a corresponding parameter of a type of the constant.

14. A computer-readable storage medium comprising computer-readable instructions which when executed cause at least one processor of a computing device to:
receive program source code written in a statically typed programming language, the program source code comprising an overloaded function, the overloaded function receiving at least one input parameter comprising a constant of a plurality of valid constants for the at least one input parameter, the overloaded function returning at least one result, a type of the at least one result dependent on the received constant, a value of the constant specified in the program source code;
map the constant to a constant specified in a signature of the overloaded function to determine a particular overload associated with the constant;
persist in a typed parse tree, type information associated with the particular overload to a node in the typed parse tree, the node representing a function that calls the overloaded function; and
display type information associated with the at least one result from the typed parse tree.

15. The computer-readable storage medium of claim 14, comprising further computer-readable instructions which when executed cause the at least one processor to:
map a constant specified in a signature of the overloaded function to a return type of the overloaded function.

16. The computer-readable storage medium of claim 15, comprising further computer-readable instructions which when executed cause the at least one processor to:
persist type information in the typed parse tree.

17. The computer-readable storage medium of claim 14, comprising further computer-readable instructions which when executed cause the at least one processor to:
pass a parameter into the overloaded function, wherein the parameter is of type “function”.

18. The computer-readable storage medium of claim 14, comprising further computer-readable instructions which when executed cause the at least one processor to:
pass a second parameter into the overloaded function, wherein a type of the second parameter depends on a value of the constant passed into the overloaded function.

19. The computer-readable storage medium of claim 14, comprising further computer-readable instructions which when executed cause the at least one processor to:
overloading a function in a type system, the function taking a particular parameter type, where a parameter the function takes depends on a constant associated with the function.

20. The computer-readable storage medium of claim 14, comprising further computer-readable instructions which when executed cause the at least one processor to:
receive a constant, the constant comprising an expression used at compile time for type checking.
